(19) United States
(12) Patent Application Publication
(10) Pub. No.: US 2019/0338168 A1
(43) Pub. Date: Nov. 7, 2019

(54) Biobased hot-melt adhesive including lignin as a component

(71) Applicant: Teknologian tutkimuskeskus VTT Oy, Espoo (FI)

(72) Inventors: Christiane Laine, VTT (FI); Tiina Liitiä, VTT (FI); Jarmo Ropponen, VTT (FI); Pia Willberg-Keyriläinen, VTT (FI); Riku Talja, VTT (FI)

(21) Appl. No.: 16/475,383

(22) PCT Filed: Jan. 2, 2018
(86) PCT No.: PCT/FI2018/050005

§ 371 Date: Jul. 2, 2019

(30) Foreign Application Priority Data
Jan. 2, 2017 (FI) 20175001

(51) Int. Cl. C09J 11/08; C09J 11/06; C09J 7/38; C09J 7/35

(52) U.S. Cl. CPC C09J 11/08; C09J 11/06; C09J 7/38; C09J 2205/102; C09J 2401/00; C09J 2497/00; C09J 2203/334; C09J 7/35

(57) ABSTRACT

The present invention relates to an adhesive mixture, containing one or more cohesive polymers, one or more tackifiers and optionally one or more separate plasticizer, wherein at least one tackifier is selected from lignin or derivatized lignin. The invention also relates to the use of lignin or derivatized lignin as adhesion promoting components in particularly hot-melt or pressure-sensitive adhesives

### BACKGROUND OF THE INVENTION

### Field of the Invention

The present invention relates to adhesive compositions. In particular, the invention concerns the valorisation of lignins as tackifiers or waxy components in biobased hot-melt or pressure sensitive adhesives, as well as novel adhesive compositions suitable for use as said hot melt or pressure sensitive adhesives.

The primary target uses for these products are packages and labels, where said adhesive can provide either permanent or removable attachment.

### Description of Related Art

Development of materials from natural polymers for different applications has been of great interest for several years due to increasing prices of petrochemicals and increasing environmental concerns.

Starch-derived chemicals have been developed for decades, but recently attention has been drawn to their conflicting demand as also part of the food supply chain. Therefore, non-food alternatives abundantly present in nature are of great interest and could have great potential for material applications.

Lignin is the most important by-product from lignocellulosic biorefineries, and valuable renewable resource for biobased materials. Annually over 50 million tons of kraft lignin is extracted from wood as a by-product of the pulping industry. In the future, even more is expected to originate from the 2^{nd} generation bioethanol production as a lignin rich hydrolysis residue after enzymatic hydrolysis and fermentation stages. Currently the lignocellulosic biorefineries are actively looking for opportunities to valorise the lignin by-products in high-value products instead of direct energy production.

One particular field where alternative biobased materials are sought is in hot melt and pressure sensitive adhesive compositions. Hot melt adhesives (HMA) are used, e.g., in book binding, packaging, woodworking and the textile industries. Pressure-sensitive adhesives (PSA) are, in turn, used in tapes and in labelling applications of food, household, pharmaceutical and industrial products.

Hot melt adhesives (HMA) are a form of thermoplastic adhesive that is liquid when hot, and solidifies in a period of a few seconds to one minute when cooled down.

Pressure-sensitive adhesives (PSAs) are adhesives that typically adhere to substrates when pressure is applied. The glue seam formed is not permanent, and substrate is removable.

The pressure-sensitive adhesives (PSAs) are a type of sub-group of hot-melt adhesives, i.e. high-viscosity PSA mixtures that are heated to reduce viscosity enough to allow application onto a substrate, and subsequently they are cooled to their final form. They are thus capable of being applied as dispersions, solutions or hot melts, and subsequently give rise to a rubbery, tacky film of relatively low adhesive strength and higher cohesive strength at the service temperature.

Typically, pressure-sensitive adhesives can be used to produce bonds that are permanent, but not creep resistant. Importantly, they can also be employed for giving rise to temporary or serial temporary bonds. PSAs are frequently uses supported on flexible substrates.

HMAs (hot-melt adhesives) are available in a variety of different types, allowing for use in a wide range of applications across several industries (see Cope B. C. (2005) Adhesive classification). For use with hobby or craft projects such as the assembly or repair of remote control foam model aircraft, and artificial floral arrangements, hot-melt sticks and hot-melt glue guns are used in the application of the adhesive. For use in industrial processes, adhesive is supplied in larger sticks and glue guns with higher melting rates. Aside from hot melt sticks, HMA can be delivered in other formats such at granular or power hot melt blocks for bulk melt processors. Larger applications of HMA traditionally use pneumatic systems to supply adhesive.

Examples of industries where HMAs are used include: Carton sealing and labeling applications in the packaging industry, Spine gluing in the bookbinding industry, Profile-wrapping, product assembly and laminating applications in the woodworking industry, Disposable diapers are constructed through the use of HMA, bonding the non-woven material to both the backsheet and the elastics, Many electronic device manufacturers may also use an HMA to affix parts and wires, or to secure, insulate, and protect the device's components, and HMA are regularly used to assemble and seal, corrugated boxes and paperboard cartons.

Typically, they comprise a main constituent (a base material) comprising or consisting of a polymer, blended at least with a tackifier, and optionally with additional components, such as waxes and plasticizers. When applied upon a surface or into an interface, they give rise to a solid structure that is load-bearing at temperatures at which the treated surface or interface is being used (also called the operational temperature or the service temperature).

In the formed adhesive, the nature of the polymer and of the tackifier influences the nature of mutual molecular interaction and interaction with the substrate. Hot melt adhesives melt and form mobile liquids at a higher application temperature.

New biobased raw materials suitable for use in these conditions are of interest and may offer a new value chain from biorefineries to adhesive producers.

In industrial use, hot melt adhesives provide several advantages over solvent-based adhesives. Volatile organic compounds are reduced or eliminated, and the drying or curing step is eliminated. Hot melt adhesives have a long shelf life and can usually be disposed of without special precautions. HMAs also maintain their thickness when solidifying.

Hot melt adhesives are on the front lines for several reasons in gluing. One factor is the wide variety of large commercial applications especially in the environmentally sensitive areas of packaging. Another factor is that hot melt adhesives have grown and replaced other adhesive types primarily due to favorable environmental factors.

Cellulose derivatives are an interesting option for hot melt adhesives as strength providing cohesive polymer, and as biobased replacement for typically used synthetic polymers. However, the production of these polymers includes commonly degradation before they exhibit sufficient softness for use in hot melts.

Lignin is non-linear phenolic biopolymer with rather low molar mass, and thus not suitable for strength providing cohesive polymer. However, the crosslinked resin-like structure could serve as a tackifier, replacing current higher-price products (e.g rosin and terpene-phenol resins).

US20110054154 describes a thermoplastic material, useful in e.g. asphalt for roads and roofs, insulation facing and hot melt adhesives, comprising a mixture of lignin, polyol (e.g. polyethylene glycol) and melting point reducer (e.g. tall oil). However, hot melt adhesives are only mentioned as potential application area for lignin, and lignin was not tested in any HMA formulations.

DE 102012207868 describes a pressure sensitive adhesive with 98% of biodegradable content based on natural rubber, lignin and tackifier resin. In this case, lignin was not used as tackifier, and the concentration of lignin related to the entire pressure-sensitive adhesive weight was rather low, only 0.5-20 weight %, i.e. lower compared to the present invention.

CN 104707167, in turn, describes a sweet gum resin-chitin-gallic acid pressure sensitive adhesive, comprises sweetgum resin, chitin, gallic acid, poly(lactic-co-glycolic acid), lignosulfonate, antioxidant, plasticizer and softening agent. The lignosulfonates were only used as an additive in a complex glue formulation, and no other industrial lignins were included.

There is a clear customer need for biobased adhesives utilizing non-food raw materials, such as lignin, and wherein both the raw materials and the product mixtures are easily modified. Stringent environmental regulations are driving the demand for water-based or solvent-free adhesives, promoting the development of HMAs.

### SUMMARY OF THE INVENTION

It is an aim of the invention to eliminate at least some of the problems of the prior art and to provide novel natural materials which are useful for various adhesive applications.

The present invention is based on the finding that lignins are useful as adhesion promoting components.

The suitability of various technical lignins as tackifier or waxy component in hot melt or pressure sensitive adhesives has not been studied previously.

Thus, according to a first aspect of the present invention, there is provided an adhesive mixture, with lignin included as a component.

Particularly, there is provided an adhesive mixture containing one or more cohesive polymers, one or more tackifiers and one or more plasticizer. Typically, lignin or a lignin derivative forms the tackifier due to its capability to form hydrogen bonds with both polymers and typical substrate materials, but can also have a plasticizing effect, depending on its structure and functional groups.

According to a second aspect of the invention, there is provided an adhesive produced from the above mentioned adhesive mixture.

According to a third aspect of the invention, there is provided a method for providing an adhesive substrate surface.

According to a fourth aspect of the invention, there is provided a use of lignin or derivatized lignin as adhesion promoting components in adhesives.

In the hot-melt adhesives (HMAs) and the present pressure-sensitive adhesives (PSAs) of the invention, the gluing performance is based on physical interactions rather than chemical reactivity, particularly on hydrogen bonds and hydrophobic interactions. Thus, the limited reactivity of lignin is not such an obstacle as in typical thermoset resins that are presently extensively studied for wood gluing.

Based on the above, it is possible to provide adhesive compositions, containing or consisting of one or more lignins or lignin derivatives as a mixture with one or more other components selected from the group of cohesive compounds, and optionally with one or more external plasticizers.

The invention enables the use of lignin as such or after derivatisation as component in hot melt (HMA) or pressure sensitive (PSA) adhesives. Lignin is a highly suitable material for use in such applications, among others due to its distinct thermal behavior both at elevated temperature, such as in HMA processing, and at lower temperatures, such as in the use of final products, as well as due to its capability of forming hydrogen bonds with polymers and typical substrate materials.

Lignin also has the advantage of opening up a vast number of opportunities for formulating variable HMA and PSA adhesives via the adjustment of the lignin properties (e.g. thermoplasticity, hydrophobicity/hydrophilicity) by chemical modification (chain length of substituent, degree of substitution), and/or using different component ratios. Performance can be affected also by the origin of lignin raw material, i.e. feedstock and process.

Further, using the described components, the HMAs or the PSAs can be produced without the use of organic solvents or other volatile organic compounds (VOCs).

### BRIEF DESCRIPTION OF THE DRAWING

FIG. 1 shows the structure of optionally modified lignin with improved thermoplastic properties, in accordance with at least some embodiments of the present invention.

### EMBODIMENTS OF THE INVENTION

In the present context, the term “cohesive agent” or “cohesive polymer” is intended to describe the component of an adhesive that provides the adhesive with internal strength, i.e. that hold the various components of the adhesive together. The cohesion is thus provided by the bonds within the cohesive polymer, by crosslinking, by intermolecular interactions, and by mechanical adhesion between the molecules.

The term “tackifier”, in turn, is intended to describe the component of an adhesive that provides the adhesive with external strength, i.e. that is capable of holding the adhesive and the substrate together.

“Plasticizers” are components that increase the fluidity of mixtures and compositions, and making them softer. “External” plasticizers are separate components added to the adhesive mixtures to increase their plasticity, while “internal” plasticizers are inherent parts of the polymer molecules and become part of the product. Internal plasticizers can be either co-polymerized into the polymer structure or reacted with the original polymer.

The adhesives (also called glues) of the invention include hot-melt adhesives (HMA), which are soft and tacky when hot, and solidify upon cooling, as well as pressure-sensitive adhesives (PSA), which adhere to substrates when pressure is applied.

In these HMAs and PSAs, the gluing performance is based on physical interactions rather than chemical reactivity, particularly on hydrogen bonds and hydrophobic interactions. Thus, the limited reactivity of lignin is not such an obstacle as in thermoset resins that have been extensively studied for wood gluing.

The pressure-sensitive adhesives (PSAs) of the present invention are a type of sub-group of hot-melt adhesives, i.e. high-viscosity PSA mixtures that are heated to reduce viscosity enough to allow application onto a substrate, and subsequently they are cooled to their final form.

At least some of the present embodiments relate to an adhesive mixture containing one or more cohesive agents, one or more tackifiers, and optionally one or more separate plasticizer.

Typically, the lignin component of the present adhesive mixture functions as a tackifier. The effect is based on interactions with the substrate and the other glue components. The hardness or cohesion of the mixture is, in turn, typically affected using polymers.

Separate plasticizers or softeners are not necessarily required in the composition. In some embodiments, the lignin components will provide sufficient softening.

The adhesive mixture is typically applied onto a substrate to form a hot-melt or pressure-sensitive adhesive, which form a gluing surface upon hardening. Such adhesives can either have a permanent gluing effect or can be of a detachable type (e.g. in the form of a detachable sticker or a post-it note).

The cohesive compounds of the adhesives are typically polymeric. Some biobased alternatives include polylactic acid (PLA), natural rubber and various polysaccharides, although currently mainly synthetic polymers are used.

Of the suitable base materials for use as cohesive compounds, ethylene-vinyl acetate (EVA) copolymers are among the preferred ones. These EVA copolymers provide sufficient strength between 30 and 50° C. High amounts of tackifiers are often used with these. EVA can be crosslinked, yielding a thermosetting material, and can also be grafted to other compounds to improve adhesion. The EVA copolymers are commonly used in packaging applications.

Polyolefins (PO) (such as polyethylene (PE), polypropylene (PP), or polybutene) are alternatives for use as cohesive compounds, offering good adhesion, good moisture barrier, chemical resistance against polar solvents and solutions of acids, bases, and alcohols. However, particularly PE and PP are usually used on their own or with just a small amount of tackifiers, whereby they are less useful when preparing the present natural adhesive mixtures. Polyolefins are compatible with many solvents, tackifiers, waxes, and polymers, and they find wide use in many adhesive applications.

Polyamides (PA) and polyesters (such as acetates) give high-performance and high-temperature glues. They are resistant to plasticizers, oils and gasoline, and exhibit good adhesion to many substrates such as metal, wood, vinyl, and treated polyethylene and polypropylene. Polyamides and polyesters can be formulated as soft and tacky or as hard and rigid. They are used where high tensile strength and high temperature resistance are needed.

According to an embodiment of the invention, the most preferred cohesion polymers for use in the present invention are cellulose acetate (CA), oxidized cellulose acetate (CA-Ox) and ethyl vinyl acetate (EVA), particularly CA-Ox and EVA. Another preferred alternative is polycaprolactone (PCL).

Of said preferred cohesive polymers, CA-Ox has a lower Mw, and is more hydrophilic. CA-Ox has a Tg of 134° C. Cellulose acetate (CA), in turn, has a higher Mw, is more hydrophobic, and has a Tg of 184° C. The properties of EVA qualities vary, but commercial EVA has a low melt viscosity, and melts at 67° C. These polymers are thus selected for slightly different applications. For example, EVA is particularly useful in packing applications.

Lignins from different sources are well applicable as tackifiers. However, the tackifying effect of lignin can be affected to some extent by the choice of lignin raw material, as well as the optional pretreatment process. Some of the potential lignins are:
Alkaline lignins, such as kraft and soda lignins, formed as a by-product of pulping industry. Kraft and soda lignins typically have rather high content of phenolic units. Molar mass of SW kraft lignin is higher compared to HW kraft lignin, or soda lignin of annual plants. Tg is rather high.
Hydrolysis lignin, formed as a by-product of bioethanol or other biochemical production process via sugars, has rather native structure and low amount of phenolic groups. Typically it contains high amount of impurities (unhydrolysed polysaccharides, proteins), and has higher Tg than kraft lignin.
Organosols lignin, prepared by solubilizing the source lignin using an organic solvent, whereby a product is obtained, which has a low molecular weight, and a high amount of phenolic groups. Due to low molar mass, the Tg is typically lower compared to kraft lignin.
AlkOx lignin, which is the by-product lignin of alkaline oxidation (AlkOx) pretreatment of biomass, developed by VTT (FI20145935). Compared to other technical lignins, it is oxidized and thus more hydrophilic. Rather low Tg has been detected for AlkOx lignins compared to kraft lignin.
Other oxidised lignins, with similar properties as the AlkOx lignin, which are obtained by the oxidation of technical lignins after their recovery.

In case further tackifiers are used, in addition to the lignin component, these are also preferably selected from biobased materials, most suitably from resins (either natural or synthetic).

According to an embodiment of the invention, the lignin raw material is used as such or it is chemically modified to further adjust the lignin properties towards optimal melt processing and gluing properties. This is done, among others, to increase its thermoplasticity.

According to another embodiment of the invention, the lignin raw material is subjected to modifications to adjust the hydrophilicity/hydrophobicity, typically by chemical modifications. This increases one or more of the properties: adhesion, interactions and compatibility with the other components of the product adhesive.

The above mentioned chemical modifications can include etherification and esterification of the aliphatic and phenolic lignin hydroxyl (OH) groups with compounds providing substituent chain length between C1 and C20, preferably by acetylation (which adds 2 carbon atoms).

According to a preferred option, the above mentioned chemical modifications include modification using fatty acids, particularly tall oil fatty acids (TOFA) e.g. as a mixture of mainly unsaturated fatty acids, particularly with the main components of the type C18:1, C18:2, and C18:3, as described in FI2012/050965, or as a mixture of fatty acids of varying chain lengths.

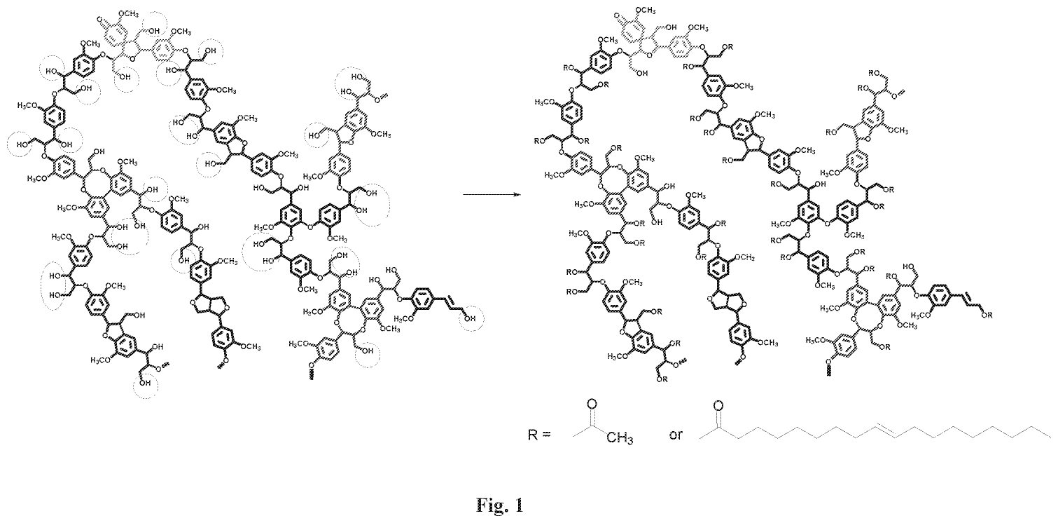

These modifications change the characteristics of the lignin by modifying the functional groups, while also adjusting the softening temperatures and the hydrophobicity of the modified lignins (see FIG. 1).

According to an embodiment of the invention, the preferred lignin types for use in the present invention are unmodified kraft lignin, AlkOx lignin, hydrolysis lignin, organosolv lignin, soda lignin and lignosulfonates. TOFA-modified lignins form one particularly preferred alternative.

The glass transition temperatures (Tg) of the most preferred lignins vary in the following order: Hydrolysis lignin>Kraft lignin˜Soda lignin>oxidized AlkOx lignin˜Organosolv lignin˜Acetylated Kraft lignin>TOFA-modified Kraft lignin.

Thus, the unmodified hydrolysis, kraft and soda lignins have the highest Tg, while the unmodified AlkOx and Organosolv lignins have a slightly lower Tg, comparable to that of acetylated lignin but are more hydrophilic, and the TOFA-modified lignin has a relatively low Tg, but functions as an internally plasticized lignin.

The thermal stability of all these lignins is high enough for use in HMAs (with a max processing temp of <160-170° C.).

According to a preferred embodiment of the invention, unmodified kraft lignin, hydrolysis lignin, organosolv lignin, soda lignin or oxidized lignin, or acetylated product of the mentioned lignins are selected as the lignin tackifier, due to their above mentioned properties. Further, the melting temperature and bond strength of the lignin formulations can be regulated
i. by the ratio of the compounds
ii. by the proportion of plasticizer, and
iii. optionally, in case of a modified lignin, by its degree of substitution.

Another preferred type of lignin is the TOFA-lignin, which can be used without any plasticizers. This enables formulations that have no components that could migrate to the products. Further, the melting and bond strength of the TOFA lignin formulations can be regulated
i. by the ratio of the compounds
ii. by the degree of substitution in the TOFA lignin, and
iii. by the proportion of optional plasticizer

According to another preferred embodiment of the invention, the tackifier is selected according to three alternatives:
i. the tackifier being unmodified lignin, mixed with external plasticizer (as well as one or more cohesive agents),
ii. the tackifier being modified, e.g. esterified, lignin, mixed with external plasticizer (as well as one or more cohesive agents), or
iii. the tackifier being modified lignin wth low Tg, e.g. TOFA lignin, used as such, without external plasticizer (but mixed with one or more cohesive agents).

Thus, according to an embodiment of the invention, an external plasticizer can be used. Any known plasticizers can be used, examples thereof including the following: triacetin, diacetin, monoacetin, triethyl citrate, tributyl citrate, acetyl triethyl citrate, acetyl tributyl citrate, dimethyl succinate, diethyl succinate, ethyl lactate, methyl lactate, fatty acid esters of glycerol, castor oil, olive oil, rapeseed oil, pine oil, waxes dibutyl phthalate, diethyl phthalate, and mixtures thereof. Triethyl citrate (TEC) as one example for several similar plasticizers is suitable for reducing the Tg as well as the viscosity of the adhesive mixture. Its content in these mixtures is typically from about 30 to about 50% by weight of the mixture.

By using lignin as a tackifier for HMAs and PSAs, formulations or adhesive mixtures have been obtained, which show equal bond strength compared to commercial reference, but exhibit other advantages compared to the references, including the components being of biological origin. Modification of the lignin is not necessary, but provides further possibilities to adjust the properties to be suitable for use in different products (e.g. to provide reversible PSA or irreversible HMA).

Higher processing temperatures are required at lower plasticizer contents, and with oxidized cellulose acteate (CAOx) compared to EVA. However, the mixtures containing CAOx in general were found to provide better adhesion than mixtures containing EVA. Therefore, the cohesive polymer is typically selected according to the desired level of adhesion, whereby CAOx is preferred in adhesives intended to provide permanent adhesion, whereas EVA is preferred in adhesives intended for detachable products, typically together with a lignin and an external plasticizer. Polycaprolactone (PCL) as an alternative cohesive polymer showed also potential for permanent adhesion.

When high processing temperatures are required, such as when using CAOx as the cohesive polymer, or when using unmodified kraft lignin as the lignin component, the plasticizer content is typically 40% or more, by weight of the entire adhesive mixture, since smaller amounts would result in an unreasonable melting point, and in an adhesive with poorer qualities.

For pressure sensitive adhesives, acetylated lignin as the lignin component and CAOx as the cohesive polymer are one preferred alternatives, particularly with TEC as the plasticizer in contents of 40% or more, by weight of the adhesive mixture. Another possibility is a formulation with high TOFA-lignin content (>70%). A third alternative are formulations in which EVA is used as cohesive polymer, together with lignin and an external plasticizer.

As a conclusion, the usual components of the adhesives of the present invention include the following:
i. high molecular weight polymers as cohesive agents or fillers, e.g., Cellulose acetate as such or after oxidation (CA or CAOx), ethylene vinyl alcohol (EVA), polyvinyl alcohol (PVA), polypropylene (PP), polyethylene (PE), polyamids (PA), polyesters (used to replace conventional alternatives including calcium carbonate, barium sulfate, talc, silica, carbon black, clays (e.g., kaolin)), acting as a backbone, and providing the required mechanical properties (cohesion, i.e. (forming an aggregate-matrix material)) and interactions of the adhesive with the substrates, among others via hydrogen bonds, another preferred alternative being polycaprolactone (PCL).
ii. lignin tackifier or tackifying resin (used to replace known tackifying resins, including, e.g., rosins and their derivates, terpenes and modified terpenes, aliphatic, cycloaliphatic and aromatic resins, hydrogenated hydrocarbon resins, and their mixtures, terpene-phenol resins (TPR)) providing the adhesion properties of the adhesive, in an amount of up to about 40-50% by weight of the adhesive. These tackifiers are of a lower molecular weight than the cohesive polymers, and typically have a glass transition temperature (Tg) that is higher than room temperature (RT).
iii. plasticizers, either in the form of the above described lignin component, or as one or more separate plasticizers (conventional examples including triacetin, diacetin, monoacetin, triethyl citrate, tributyl citrate, acetyl triethyl citrate, acetyl tributyl citrate, dimethyl succinate, diethyl succinate, ethyl lactate, methyl lactate, benzoates such as 1,4-cyclohexane dimethanol dibenzoate, glyceryl tribenzoate, or pentaerythritol tetrabenzoate, phthalates, paraffin oils, polyisobutylene, chlorinated paraffins, etc.), typically added as an oil or a wax, which controls the viscosity of the blend and enables the adhesive to be handled by simple machinery.
iv. optional waxes, e.g., synthetic waxes, fatty amide waxes or oxidized Fischer-Tropsch waxes. These waxes function by increasing the setting rate, and by lowering the melt viscosity. Further, they can improve bond strength and temperature resistance.
v. optional antioxidants and stabilizers (e.g., hindered phenols, butylated hydroxytoluene (BHT), phosphites, phosphates, hindered aromatic amines), added in small amounts (<1%), not influencing physical properties, but protecting the material from degradation or ageing (caused, e.g., by autoxidation), or UV stabilizers, or biocides for hindering bacterial growth, or flame retardants.
vi. optional pigments, dyes and glitter.
vii. and optional antistatic agents.

Properties of the adhesive mixture can be adjusted by changing the proportions of the components, as well as by modifying the lignin component.

According to an embodiment of the invention, the adhesive mixture is prepared by mixing the selected components in the desired ratios at an elevated temperature, particularly varying from about 100 to about 170° C., preferably at a temperature of 150° C. or lower.

In general, hot melts are applied to the selected substrates by jet application in its various forms (extrusion, spray, slot, spot), and the high melt viscosity makes them ideal for porous and permeable substrates. HMAs are capable of bonding an array of different substrates including: rubbers, ceramics, metals, plastics, glass and wood.

According to an embodiment of the invention, the prepared adhesive mixture is applied and glued on a suitable substrate selected from rubbers, ceramics, metals, plastics, glass, wood, paper and board substrates, with paper and board substrates being the most suitable alternatives, such as sack paper and coated board.

After application the important gluing parameters in industrial processes are the open time related to the setting behavior, and compression phase (close time/pressure).

According to a preferred embodiment, an elevated temperature and pressure are used during the application. Examples of suitable parameters include an application temperature of 100 to 200° C., preferably 120 to 190° C., and most suitably about 120-170° C.

The adhesives of the present invention can be used in a wide variety of applications, e.g., carton sealing and labeling, paperboard assembling and sealing, spine gluing in the bookbinding industry, profile-wrapping, product assembly and laminating applications in the woodworking industry, installation of flooring and ceiling panels, gluing of woven and non-woven fabrics, disposable diapers, affixing of parts and wires in electronic devices, or to secure, insulate, and protect the device's components.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1

Lignin samples originating from different feedstock and biomass pretreatment processes were compounded in a laboratory scale compounder (Micro compounder DSM Xplore Micro 15 cc Twin Screw Compounder or DACA instruments) together with a cohesive polymer and a plasticizer as shown in Table 1.

TABLE 1
Compounding and gluing performance of HMAs with unmodified lignin as tackifier.
All formulations were compounded for 10 min resulting in uniform HMAs.

| | | | Gluing | Maximum load | Maximum load/weight |
|---|---|---|---|---|---|
| Ratio of components | Compounding | Torque, | temperature, | (180° peel test), | (180° peel test), |
| in HMA formulation | T, ° C. | N | ° C. | N | N/g |
| Commercial HMA | | | 120 | 10.5 ± 3.8 | 276 |
| CAOx/SW-Kraft Lignin 1/TEC | | | | | |
| 21/29/50 | 130 | Not recorded | 120 | 6.0 ± 0.9 | 133 |
| 26/34/40 | 160 | 15 | 160 | 6.6 ± 1.3 | 142 |
| CAOx/SW-Kraft Lignin 2/TEC | | | | | |
| 21/29/50 | 160 | <5 | 160 | 6.7 ± 0.7 | 335 |
| CAOx/Soda Lignin/TEC | | | | | |
| 21/29/50 | 160 | <5 | 160 | 6.9 ± 0.7 | 355 |
| CAOx/Alkox lignin | | | | | |
| (non-washed)/TEC | | | | | |
| 21/29/50 | 130 | <5 | 140 | 3.9 ± 1.1 | 144 |
| 26/34/40 | 150 | <5 | 170 | 8.8 ± 0.6 | 191 |
| CAOx/Alkox lignin | | | | | |
| (acid washed)/TEC | | | | | |
| 21/29/50 | 160 | <5 | 140 | 10.0 ± 1.1 | 185 |
| 26/34/40 | 160 | <5 | 160 | 5.8 ± 1.2 | 152 |
| CAOx/Hydrolysis lignin/TEC | | | | | |
| 21/29/50 | 160 | <5 | 195 | 7.7 ± 0.9 | 107 |
| (Hydrolysis lignin 1) | | | | | |
| 26/34/40 | 160 | <5 | 195 | 3.0 ± 0.6 | 55 |
| (Hydrolysis lignin 2) | | | | | |
| CAOx/OS-HW/TEC | | | | | |
| 21/29/50 | 110 | <5 | 120 | 5.7 ± 2.0 | 154 |
| 26/34/40 | 120 | <5 | 120 | 6.3 ± 1.9 | 820 |
| 30/40/30 | 160 | <5 | 120 | 16.1 ± 0.8 | 690 |
| PCL/Kraft lignin/TEC | | | | | |
| 30/40/30 | 160 | <5 | 150 | 4.3 ± 1.1 | 121 |
| EVA/Kraft Lignin/TEC | | | | | |
| 21/29/50 | 110 | Very low | 120 | 0.5 ± 0.1 | 10 |
| 26/34/40 | 120 | 3 | 120 | 0.6 ± 0.2 | 33 |
| 30/40/30 | 150 | 33 | 150 | 1.6 ± 0.8 | 46 |

CAOx—oxidized cellulose acetate according to WO 2014/080086 A1,
TEC—triethyl citrate,
SW-Kraft Lignin1: Commercial softwood kraft lignin.
SW-Kraft Lignin2: Softwood kraft lignin prepared from industrial black liquor according to FI20155505
Soda-Lignin: Commercial wheat straw soda lignin (Protobind-1000, Green Value).
AlkOx lignin—oxidized side stream lignin from AlkOx process (FI20145935); non-washed sample isolated by ultrafiltration and diafiltration with high ash content; acid washed sample is the same after washing four times at pH 2.5 using centrifugation to recover the lignin to remove excess ash
Hydrolysis lignin—Hydrolysis lignin obtained by enzymatic hydrolysis of steam exploded recycled wood;
OS lignin—Eucalyptus organosolv lignin prepared by VTT's LignoFibre method using ethanol solvent and phosphinic acid catalyst according to Liitiä et al (2014).
EVA—commercial ethylene vinyl acetate
PCL—commercial polycaprolactone

The properties of the lignin samples are shown in Table 2 including glass transition temperature, degradation temperature and content and quality of hydroxyl groups.

TABLE 2
Characterization of lignin samples

| | Aliph OH | Phenolic OH | | | | | Mw |
|---|---|---|---|---|---|---|---|
| Lignin samples | mmol/g | mmol/g | COOH | 1st Tg * | 2nd Tg | T_{deg10%} | g/mol |
| SW Kraft lignin 1 | 1.6 | 3.4 | 0.3 | 153 | 153 | 316 | 4 700 |
| SW Kraft lignin 2 | 0.77 | 6.3 | 0.8 | — | — | — | 4 500 |
| Soda lignin | 1.4 | 3.4 | 0.9 | 137.7 | 140.6 | — | 3 300 |
| OS-HW lignin | 1.7 | 3.1 | 0 | 121.0 | 130.6 | — | 3 |
| | | | | | | | 100 |
| Alkox lignin | 4.1 | 0.6 | 1.6 | 190 after | n.d. | 245 | 7700 |
| | | | | washing | | | |
| SE lignin 1 | — | — | — | 188 | | — | — |
| SE lignin 2 | — | — | — | 179 | | — | — |

OH—hydroxyl group;
COOH—Carboxylic acid group;
Tg—glass transition temperature,
T_{deg10%}—10% weight loss temperature.

The glass transition temperature was determined using a differential scanning calorimeter (DSC; model DSC2, Mettler Toledo GmbH, Switzerland). Approximately 4 mg of the samples were measured in standard aluminium crucibles, volume 40 ul, that had been oxidized before use. The crucible was closed hermetically by cold-pressing. The lid was pricked prior to measurement allowing evaporation of volatile substances. An Intra-cooler (Huber, TC100MT) was used allowing minimum starting temperature of −90° C. The nitrogen flow was 80 ml/min to purge measurement cell and prevent water condensation and the dynamic heating rate was 10 K/min. Each sample was subjected to the temperature program including the predrying cycle at 105° C. before two cycles from 60 to 200° C. and 325° C.

The decomposition characteristics of the samples were investigated with thermal gravimetric analysis (TGA; STA 449 F1, NETZSCH-Geratebau GmbH, Germany). The measurements were carried out in air with a temperature program from 35 to 1000° C. with a heating rate of 5K/min.

The hydroxyl groups were determined by phosphorous nuclear magnetic resonance spectroscopy (Granata & Argyropoulos, 1995) and the molar mass distribution data using size exclusion chromatography (SEC). The SEC measurements were performed in 0.1 M NaOH eluent (pH 13, 0.5 ml/min, T=25° C.) using PSS MCX 1000 & 100000 Å columns with a precolumn. The elution curves were detected using Waters 2998 Photodiode Array detector at 280 nm. The molar mass distributions (MMD) were calculated against polystyrene sulphonate (8×PSS, 3420-148500 g/mol) standards, using Waters Empower 3 software.

The parameters during compounding are listed in the above Table 1. The obtained HMAs were used as an adhesive between two commercial folding box board stripes (width 25 mm). The hot melt adhesive was placed at one end of the pigment-coated side of the stripe. On the top of this construction, the other stripe was placed against the hotmelt adhesive with the uncoated side. The gluing was finalized in an oven under 2 kg weight at temperatures shown in Table 1. The obtained t-shaped sample was tested using an Instron universal testing machine. The ends of the sample were clamped in the cross-head grips of the tensile testing machine. A load of a constant cross-head speed (1.67 mm/s) was applied and the maximum debonding load was recorded for six parallel samples. The debonding load of the specimens varied from 0.5 to 1.6 N for the EVA/Kraft Lignin/TEC adhesives, 4.3 N for the PCL (Kraft lignin/TEC adhesives, from 6.0 to 6.7 N for the CAOx/Kraft Lignin/TEC adhesives, 6.9 for the CAOx/Soda Lignin/TEC adhesives, 3.9-10.0 for the CAOx/AlkOx Lignin/TEC adhesives, from 5.7 to 16.1 N for the CAOx/Organosolv Lignin/TEC adhesives, and was 3.0-7.7 for CAOx/Hydrolysis Lignin/TEC adhesives. Lignin was used successfully in these experiments as adhesive component, and the formulation reached the level of the reference (10.5±3.8 N). When the weight of the applied glue was taken into account (Maximum load/weight), even higher values than for the reference were obtained with the several CAOx/Lignin/TEC adhesives.

### Example 2

An acetylated lignin sample was compounded in a laboratory scale compounder (DACA instruments) together with a cohesive polymer and a plasticizer as shown in Table 3 (below), together with the gluing parameters and performance. The properties of the lignin acetate sample are shown in the following Table 4 including glass transition temperature, degradation temperature and content and quality of hydroxyl groups. The methods are described in Example 1, and the preparation of the acetylated lignin after Table 4.

TABLE 3
Compounding and gluing performance of HMAs with acetylated lignin as tackifier.
All formulations were compounded for 10 min resulting in uniform HMAs.

| | | | Gluing | Maximum load | Maximum load/weight |
|---|---|---|---|---|---|
| Ratio of components | Compounding | Torque, | temperature, | (180° peel test), | (180° peel test), |
| in HMA formulation | T, ° C. | N | ° C. | N | N/g |
| Commercial HMA | | | 120 | 8.8 ± 0.6 | 246 |
| CAOx/Acetylated Lignin/TEC | | | | | |
| 30/40/30 | 150 | Not recorded | 120 | 8.7 ± 0.9 | 122 |
| 26/34/40 | 130 | Not recorded | 120 | 8.4 ± 0.3 | 100 |
| 21/29/50 | 130 | Not recorded | 120 | 8.2 ± 0.5 | 121 |

TABLE 4
Properties of the used lignin acetate sample.

| | Aliph OH | Phenolic OH | | 1st | 2nd | |
|---|---|---|---|---|---|---|
| | mmol/g | mmol/g | COOH | Tg * | Tg | T_{deg10%} |
| Lignin | 0 | 0.4 | 0 | 134 | — | 287 |
| acetate | | | | | | |

OH—hydroxyl group;
COOH—Carboxylic acid group;
Tg—glass transition temperature,
T_{deg10%}—10% weight loss temperature;

Softwood kraft lignin was acetylated as follows: 10 g predried kraft lignin (with 5.28 mmol/g OH groups) was placed in the reaction flask together with 4-dimethyl amino pyridine (DMAP, 0.50 g, 4.09 mmol) and acetic anhydride (20.0 g, 194 mmol). The reaction was carried out under nitrogen atmosphere at 50° C. for 6 hours. The reaction was quenched with 20 ml of ethyl acetate. The mixture was concentrated and precipitated with water, filtered and washed thoroughly with water. Solid was dried at vacuum oven and the product was obtained as a light brown powder. The yield was quantitative.

### Example 3

An internally plasticized TOFA lignin was used for both components—tackifier and plasticizer together with oxidized cellulose acetate or commercial PCT. The gluing performance and properties of the TOFA lignin samples are shown in Table 5 and 6, respectively. The methods are described in Example 1, and the preparation of TOFA-lignin after the Table 6.

TABLE 5
Compounding and gluing performance of HMAs with TOFA lignin as tackifier and plasticizer.
All formulations were compounded for 10 min resulting in uniform HMAs.

| | | | Gluing | Maximum load | Maximum load/weight |
|---|---|---|---|---|---|
| Ratio of components | Compounding | Torque, | temperature, | (180° peel test), | (180° peel test), |
| in HMA formulation | T, ° C. | N | ° C. | N | N/g |
| Commercial HMA | | | 120 | 8.8 ± 0.6 | 246 |
| CAOx/TOFA-L 100 | | | | | |
| 10/90 | 130 | Not recorded | 120 | 0.8 ± 0.2 | 92 |
| 30/70 | 140 | Not recorded | 120 | 5.3 ± 0.7 | 101 |
| 50/50 | 160 | <5 | 195 | 8.9 ± 1.4 | 262 |
| CAOx/TOFA-L 95 | | | | | |
| 10/90 | 150 | | 120 | 8.2 ± 0.5 | 143 |
| CAOx/TOFA-L 70 | | | | | |
| 30/70 | 160 | <5 | 160 | 3.0 ± 0.9 | 35 |
| PCL/TOFA-L 100 | | | | | |
| 10/90 | 100 | <5 | 100 | 6.6 ± 1.6 | 229 |
| 30/70 | 100 | <5 | 100 | 4.4 ± 0.9 | 179 |

TABLE 6
Properties of the used TOFA lignin sample.

| | Aliph OH | Phenolic OH | | 1st | 2nd | |
|---|---|---|---|---|---|---|
| | mmol/g | mmol/g | COOH | Tg * | Tg | T_{deg10%} |
| TOFA- | 0 | 0 | 0.3 | −14** | n.d. | 278 |
| L 100 | | | | (broad) | | |
| TOFA- | 0.2 | 0.3 | 0.1 | 14 | n.d. | 250 |
| L 95 | | | | | | |

TOFA-L—tall oil fatty acid derivatives of kraft lignin;
OH—hydroxyl group;
COOH—Carboxylic acid group;
Tg— glass transition temperature,
T_{deg10%}—10% weight loss temperature;
* Tg values from midpoint,
**from onset;
n.d. = not detected

TOFA-esterification of softwood kraft lignin was performed via anhydride route. First TOFA-anhydride was prepared: TOFA (8.3 kg) and dichloromethane (4.1 L) were added to the reactor at room temperature and were mixed well at room temperature. After that, the reactor was cooled down to 5° C. and N,N′-dicyclohexylcarbodiimide (DCC, 3.1 kg) was added slowly. The mixture was stirred over night at room temperature, solids were filtered off and the solvent was evaporated by rotavapor. Yield of clear liquid 62%.

TOFA-L-100 was prepared by adding 500 g kraft lignin (with 2.99 mol phenolic and aliphatic OHs), pyridine (1044 g) and 4-Dimethylaminopyridine (DMAP, 32.2 g) to the reactor at room temperature. TOFA-anhydride (2433 g) was added and the reaction mixture was mixed over night at room temperature. After that, 5 L of ethanol was added to the reactor with mixing. The mixing was stopped, and during 30 minutes the product was precipitated as tar like substance. The ethanol was removed by low pressure suction, and the product was washed twice with 1-2 L ethanol. Then the reaction mixture was dried in vacuum oven (temperature <40° C.). Yield of dark brown viscous product was 82%. TOFA-L-95 and TOFA-L-70 were prepared accordingly but using lower amount of reagents.

### INDUSTRIAL APPLICABILITY

The present material can be used in, e.g., carton sealing and labeling, paperboard assembling and sealing, spine gluing in the bookbinding industry, profile-wrapping, product assembly and laminating applications in the woodworking industry, installation of flooring and ceiling panels, gluing of woven and non-woven fabrics, disposable diapers, affixing of parts and wires in electronic devices, or to secure, insulate, and protect the device's components.

In particular, the present material is useful for replacing the oil based conventional HMA and PSA adhesives with biobased formulations using lignin or lignin derivatives as tackifiers together with cellulose derivatives.

### Abbreviations

AlkOx=alkaline oxidation
AlkOx lignin=oxidized lignin from AlkOx process
BHT=butylated hydroxytoluene
CA=cellulose acetate
CAOx or CA-Ox=oxidized cellulose acetate
DSC=differential scanning calorimeter
EVA=ethylene vinyl acetate
HMA=Hot-melt adhesive
HW=hardwood
OS-HW lignin=Organosols lignin
PA=polyamide
PCL=polycaprolactone
PE=polyethylene
PLA=polylactic acid
PO=polyolefin
PP=polypropylene
PSA=Pressure-sensitive adhesive
PVA=polyvinyl alcohol
RT=room temperature
SW=softwood
TEC=triethyl citrate
Tg=glass transition temperature
TOFA=Tall oil fatty acid
TPR=terpene-phenol resins
VOC=volatile organic compound

### CITATION LIST

### Patent Literature

CN 104707167
DE 102012207868
FI20145935
FI20155505_26.6.2015
US20110054154
WO 2014/080086 A1

### Non-Patent Literature

Cope B. C. (2005) “Adhesive classification”, in Handbook of Adhesion, Ed. D. E. Packham, John Wiley & Sons, Ltd, Chichester, UK, pp. 25-28.
Granata, A., Argyropoulos, D. S. 2-Chloro-4,4,5,5-tetramethyl-1,3,2-dioxaphospholane, a reagent for the accurate determination of the uncondensed and condensed phenolic moieties in lignins. J. Agric. Food Chem. 1995, 43:1538-1544.
Liitiä., T., Rovio, S., Talj a, R., Tamminen, T., Rencoret, J., Gutiérrez, A., del Rio, J. C., Saake, B., Schwarz, K. U. Vila Babarro, C., Gravitis, J., Orlandi, M. Structural characteristics of industrial lignins in respect to their valorisation, 13th European Workshop on Lignocellulosics and Pulp (EWLP2014), Seville, Spain, Jun. 24-27, 2014.

1. An adhesive mixture comprising one or more cohesive polymers, one or more tackifiers, and optionally one or more external plasticizers, wherein at least the one or more tackifiers comprise lignin or derivatized lignin, and wherein the one or more tackifiers are present in an amount of 10% or more by weight of the adhesive mixture.

2. The adhesive mixture of claim 1, wherein the one or more tackifiers comprise an unmodified lignin selected from the group consisting of kraft lignin, soda lignin, hydrolysis lignin, oxidized AlkOx lignin, organosolv lignin, and lignosulphonate; or a derivatized lignin selected from the group consisting of an oxidized lignin, esterified lignin, or etherified lignin, and a combination thereof.

3. The adhesive mixture of claim 1, wherein the lignin or derivatized lignin is obtained from kraft, soda, sulfite, an organosolv or other pulping process, or after enzymatic hydrolysis of lignocellulosic biomass.

4. The adhesive mixture of claim 2, wherein the one or more tackifiers comprise an esterified lignin, wherein the esterified lignin includes a lignin component and an acid component, the acid component selected from a C1-C11 carboxylic acid or from a fatty acid or fatty acid mixture.

5. The adhesive mixture of claim 4, wherein the fatty acid comprises a tall oil fatty acid (TOFA).

6. The adhesive mixture of claim 1, wherein the one or more tackifiers are present in an amount of from 20% to 70% by weight of the adhesive mixture.

7. The adhesive mixture of claim 1, wherein the one or more cohesive polymers are selected from cellulose acetate (CA), oxidized cellulose acetate (CA-Ox), ethyl vinyl acetate (EVA), polycaprolactone (PCL), and combinations thereof.

8. The adhesive mixture of claim 1, wherein the one or more cohesive polymers are present an amount of from 10% to 40% by weight of the adhesive mixture.

9. The adhesive mixture of claim 1, wherein the adhesive mixture is internally plasticized by excluding the one or more external plasticizers and instead including at least 70% by weight of the derivatized lignin to provide a desired plasticizing effect in the adhesive mixture.

10. The adhesive mixture of claim 1, wherein the adhesive mixture comprises the one or more external plasticizers, and wherein the one or more external plasticizers are selected from the group consisting of triacetin, glycerol, triethyl citrate, and combinations thereof.

11. The adhesive mixture of claim 10, wherein the one or more external plasticizers are present in an amount of 30% to 50% by weight of the adhesive mixture.

12. The adhesive mixture of claim 1, wherein the adhesive mixture is provided in dry form or as a dispersion.

13. A hot melt adhesive (HMA) or a pressure-sensitive adhesive (PSA) comprising the adhesive of claim 1.

14. A method for providing an adhesive substrate surface, the method comprising compounding the adhesive mixture of claim 1, applying the compounded mixture to a surface of the substrate, and applying pressure and an elevated temperature to the compounded mixture to provide the adhesive surface substrate.

15. The method of claim 14, wherein the applying is done at a temperature of from 100 to 200° C.

16. The method of claim 14, selecting the substrate comprises a material selected from the group consisting of rubber, ceramic, metal, plastic, glass, wood, paper and board substrate.

17. (canceled)

18. The adhesive mixture of claim 10, wherein the one or more external plasticizers are present in an amount of at least 40% by weight of the adhesive mixture.

19. The adhesive mixture of claim 9, wherein the derivatized lignin comprises a tall oil fatty acid (TOFA) derivative of lignin.

20. The adhesive mixture of claim 1, wherein the one or more cohesive polymers comprise oxidized cellulose acetate, the one or more tackifiers comprise acetylated lignin, and the one or more plasticizers are present and comprise triethyl citrate (TEC).

21. The adhesive mixture of claim 20, wherein the oxidized cellulose acetate, acetylated lignin, and one or more plasticizers are present in a ratio of from 21/29/50 to 30/40/30, respectively.
